(19) United States
(12) Patent Application Publication
(10) Pub. No.: US 2004/0257968 A1
(43) Pub. Date: Dec. 23, 2004

(54) Optical disc with super-resolution near-field structure

(75) Inventors: Hyun-ki Kim, Gyeonggi-do (KR); In-oh Hwang, Gyeonggi-do (KR); Yong-jin Ahn, Seoul (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-si (KR)

(21) Appl. No.: 10/872,420

(22) Filed: Jun. 22, 2004

(30) Foreign Application Priority Data
Jun. 23, 2003 (KR) 2003-40687

(51) Int. Cl. G11B 7/24

(52) U.S. Cl. 369/275.2; 369/94

(57) ABSTRACT

A high-density optical disc with a super-resolution near-field structure (Super-RENS) on which information is written by a beam has multi-layers formed on a substrate. The disc includes one or more Super-RENS mask layers and one or more phase-change recording auxiliary layers, each containing a highly crystalline material. The Super-RENS optical disc allows high quality signal reproduction by eliminating signal instability and unevenness that may occur during reproduction after recording data as well as low manufacturing costs and high production yields.

### CROSS-REFERENCE TO RELATED APPLICATION

This application claims the priority of Korean Patent Application No.2003-40687, filed on Jun. 23, 2003, in the Korean Intellectual Property Office, the disclosure of which is incorporated herein by reference.

### BACKGROUND OF THE INVENTION

1. Field of the Invention

The present invention relates to an optical disc, and more particularly, to an optical disc incorporating a super-resolution near-field structure (Super-RENS), designed to record and reproduce marks with a size below a resolution limit of a laser beam.

2. Description of the Related Art

Optical discs are the most widely used high-density recording media since they require a much smaller recording area per recording unit than magnetic recording media. The optical discs are classified into three basic types according to their function: read-only memory (ROM) where recorded information is only read, write-once read-many (WORM) where data can be written once, and rewritable (RW) where data can be fully recorded, erased, and rerecorded.

One example of a WORM disc is a compact disc recordable (CD-R). In a CD-R, when a 780 nm recording laser heats a recording layer made of cyanine or phthalocyanine organic dye, the heat causes decomposition of the dye layer and deformation of the surface of a substrate and a reflective layer. CD-R media are optical discs used to read a recorded signal at a low power of usually less than 1 mW. With a recording capacity of about 650 MB, they are widely used to write and read various types of data such as data, music, and video.

However, the capacities of CD-R or CD-RW media using the 780 nm recording wavelength are insufficient for storing motion pictures and high volume data for complex multimedia applications. A solution overcoming this problem is the digital versatile disc (DVD), which use a 630 to 680 nm short wavelength laser and offer storage capacities of 2.7 to 4.7 GB per side. DVDs may be divided into three basic types: read-only type (DVD-ROM), write-once type (DVD-R), and rewritable type (DVD-RAM, DVD+RW, and DVD-RW). While recording on DVD-R discs is accomplished by deforming and decomposing a recording layer by laser radiation emitted from a recording laser, recording on DVD-RAM and DVD-RW media is accomplished by changing optical properties due to phase transition of the recording layer. In particular, DVD-R media employing organic dye are receiving considerable attention due to their advantages over DVD-RAM in terms of compatibility, price, and capacity.

Capacity is an issue of great concern to various emerging recordable media (write-once and rewritable). Various approaches have been proposed to increase the capacity. The recording capacity of an optical disc greatly relies upon how densely and precisely readable small pits are packed into a given area as well as the characteristics of a laser beam that can read those pits.

A beam emitted from a laser diode and focused through an objective lens cannot be made infinitely smaller due to the effect of diffraction. On the contrary, the beam has a finite width called a diffraction limit. Where the wavelength of a light source is A and a numerical aperture (NA) of an objective lens is NA in a typical optical disc, the limit of reading resolution is λ/4NA. As shown in this relationship, using a shorter wavelength light source or a higher NA objective lens can increase the recording capacity of the disc.

However, the current laser technology poses a limitation in providing a shorter wavelength laser. Also, the manufacturing costs are too high to manufacture a high NA objective lens. Furthermore, since a working distance between a pickup and a disc significantly decreases with increasing NA of the objective lens, there is a greater risk of damaging the disc surface and data due to a collision between the pickup and the disc.

To overcome the limit of reading resolution, research into a Super-RENS optical disc has been conducted in recent years. In particular, research on a scattering type Super RENS is being actively conducted. FIG. 1 illustrates a schematic structure of a conventional Super-RENS optical disc 10. As shown in FIG. 1, the conventional Super-RENS optical disc 10 mainly uses a mask layer 13 made from metal oxide such as silver oxide (AgOₓ) and palladium oxide (PdOₓ).

Recent electron microscopic analysis on the cross-section of a Super-RENS optical disc disclosed that a metal oxide thin film used as a mask layer is decomposed during recording thus transforming the thin film and creating recording marks thereon while generating plasmons in metal particles formed during recording, thus allowing marks with a size below the resolution limit to be successfully reproduced (Kikukawa, Applied Physics Letters, 81(25), pp4697˜4699) (Dec. 16, 2002).

Meanwhile, a phase-change recording auxiliary layer 15 used in the conventional Super-RENS optical disc 10 is made of a Ge-Sb—Te or Ag—In—Sb—Te based alloy that becomes amorphous immediately after formation of the alloy thin film. Since reflectivity is too low when the phase-change recording auxiliary layer 15 is in the amorphous state, stable focusing or tracking servo cannot be achieved. If reflectivity is increased to achieve stable servo by adjusting the thickness of a multi-layer thin film, the reflectivity becomes too high in the crystalline state to achieve the desired recording sensitivity since a large amount of incident beam is reflected during recording. Thus, when the phase-change recording auxiliary layer 15 made of Ge-Sb—Te or Ag—In—Sb—Te is in amorphous state, the disc must be initialized to crystalline state before recording.

An initialization process, which is one of the most time consuming operations during optical disc production, may result in increased disc price and reduced yield. Furthermore, insufficient initialization may lead to recording of unstable or uneven signals.

Upon recording on the disc that has undergone the initialization process, the metal oxide mask layer 13 decomposes to form marks, and at the same time the phase-change recording auxiliary layer 15 is melted and then rapidly quenched into the amorphous state. In this case, to achieve super-resolution, a high power reading beam heats the phase-change recording auxiliary layer 15 to change it from the amorphous state to the crystalline state.

Defective crystallization of the phase-change recording auxiliary layer 15 also may make a signal uneven or unstable. FIGS. 2A and 2B show the degradation of an RF signal reproduced when no data is recorded in case of insufficient crystallization. More specifically, FIGS. 2A and 2B show RF signals reproduced at laser powers of 2 and 3 mW after initialization without recording, respectively. This demonstrates the fact that initialization of the phase-change recording auxiliary layer 15 was incomplete due to its low crystallization rate.

Similarly, when a high readout power is applied to obtain the best carrier-to-noise (C/N) ratio upon reproducing an RF signal after data has been recorded, incomplete crystallization of the phase-change recording auxiliary layer 15 causes degradation of the RF signal over time, which worsens the C/N ratio and jitter characteristics.

FIGS. 3A and 3B show the degradation of an RF signal reproduced after data has been recorded in case of insufficient crystallization. FIG. 3A shows an RF signal reproduced at a laser power of 2.5 mW immediately after data has been recorded while FIG. 3B shows an RF signal reproduced at a laser power of 2.5 mW after a predetermined period of time has passed since data was recorded, for example 10 minutes.

FIGS. 4A and 4B illustrate a decrease in C/N ratio due to an increase in noise. In FIG. 4A, a noise level is −59.3 dB, and as shown in FIG. 4B, the noise level increases to −56.3 dB although a carrier level remains constant after time for reproduction has passed. Thus, increased noise level decreases the C/N ratio, which is obtained by subtraction of a noise level from a carrier level.

### SUMMARY OF THE INVENTION

An aspect of the present invention provides an optical disc with a super-resolution near-field structure (Super-RENS) designed to allow high quality signal reproduction by eliminating instability and unevenness of a reproduced signal due to insufficient crystallization during reproduction after recording data as well as low manufacturing costs and high production yields.

According to an aspect of the present invention, there is provided an optical disc having multi-layers formed on a substrate on which a beam writes information. The optical disc may include one or more mask layers having a super-resolution near-field structure and one or more phase-change recording auxiliary layers, each containing a highly crystalline material. The phase-change recording auxiliary layer is in a crystalline state after being formed. The highly crystalline material may be antimony telluride (Sb₂Te₃) or Sb.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a schematic diagram of a conventional optical disc having a super-resolution and near-field structure (Super-RENS);

FIGS. 2A and 2B show the degradation of an RF signal reproduced when no data is recorded in case of insufficient crystallization of a conventional phase-change recording auxiliary layer;

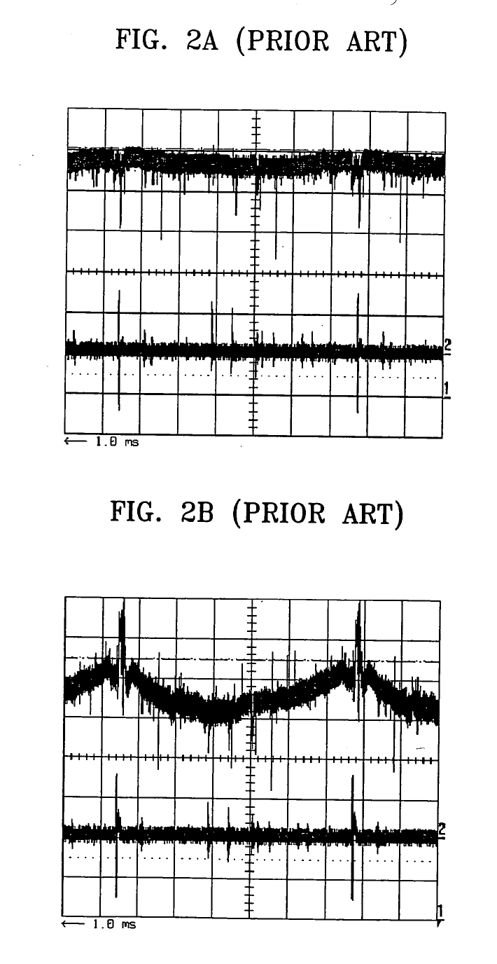

FIGS. 3A and 3B show the degradation of an RF signal reproduced after data has been recorded in case of insufficient crystallization of a conventional phase-change recording auxiliary layer;

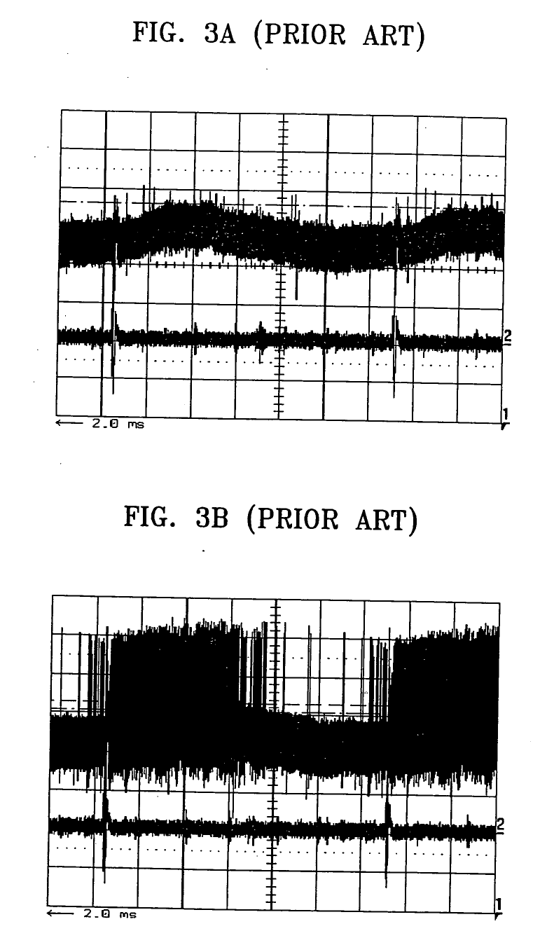

FIGS. 4A and 4B illustrate a decrease in carrier-to-noise (C/N) ratio due to an increase in noise after time for reproduction has passed;

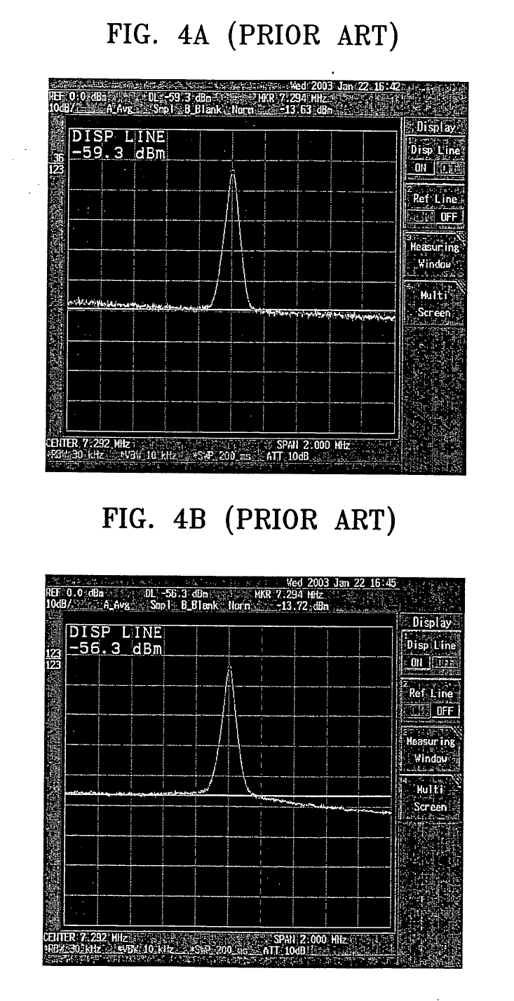

FIG. 5 is a schematic diagram of a Super-RENS optical disc according to an embodiment of the present invention;

FIGS. 6A and 6B show RF signals reproduced from an initialized Super-RENS optical discs at different linear velocities according to aspects of the invention; and

FIGS. 7A and 7B show C/N characteristics of two Super-RENS optical discs having different recording auxiliary layers according to aspects of the invention.

### DETAILED DESCRIPTION OF THE EMBODIMENTS

Reference will now be made in detail to the embodiments of the present invention, examples of which are illustrated in the accompanying drawings, wherein like reference numerals refer to the like elements throughout. The embodiments are described below to explain the present invention by referring to the figures.

An optical disc with a super-resolution near-field structure (Super-RENS) according to an embodiment of the present invention uses a phase-change recording auxiliary layer in a crystalline state immediately after formation of the thin film.

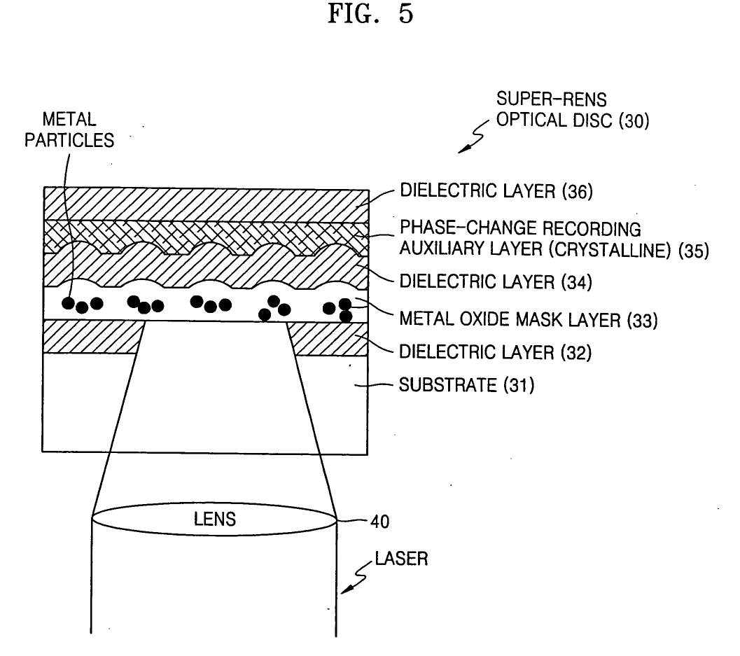

FIG. 5 shows a Super-RENS optical disc 30 according to an embodiment of the present invention. Referring to FIG. 5, the Super-RENS optical disc 30 includes a substrate 31, a metal oxide mask layer 33 and a phase-change recording auxiliary layer 35 sequentially formed over the substrate 31. The Super-RENS optical disc 30 further has dielectric layers 32, 34, and 36 formed between the substrate 31 and the metal oxide mask layer 33, between the metal oxide mask layer 33 and the phase-change auxiliary layer 35, and on the phase-change auxiliary layer 35, respectively.

The substrate 31 is made from a material providing excellent transparency, impact and heat resistance, and rigidity at a wavelength of a recording laser. The material is selected among those that can form the substrate 31 using a commonly manufacturing method such as injection molding. Examples of those materials include polycarbonate, polymetyl metacrylate, epoxy, polyester, and amorphous polyolefin. The metal oxide mask layer 33 may be made from silver oxide (AgOₓ) or platinum oxide (PtOₓ) as in a conventional optical disc, or other metal oxide. The phase-change recording auxiliary layer 35 is formed from a highly crystalline material. The highly crystalline material refers to a material that can be heated beyond the crystallization temperature into an amorphous phase and then rapidly changed back to a crystalline phase. The highly crystalline material may be antimony telluride (Sb₂Te₃) or Sb. The phase-change recording auxiliary layer 35 made from Sb₂Te₃ or Sb is in a crystalline state immediately after its formation.

Since the crystallization temperature of Sb₂Te₃ or Sb is very low, it is possible to rapidly crystallize Sb₂Te₃ or Sb by the kinetic energy of ions moving quickly from a target toward the Sb₂Te₃ or Sb thin film during sputtering for thin film formation so that it becomes crystalline immediately after formation of the thin film. As the content of Sb increases, the crystallization rate increases. Thus, the use of the Sb₂Te₃ or Sb material in formation of the phase-change recording auxiliary layer 35 eliminates the need for a separate initialization.

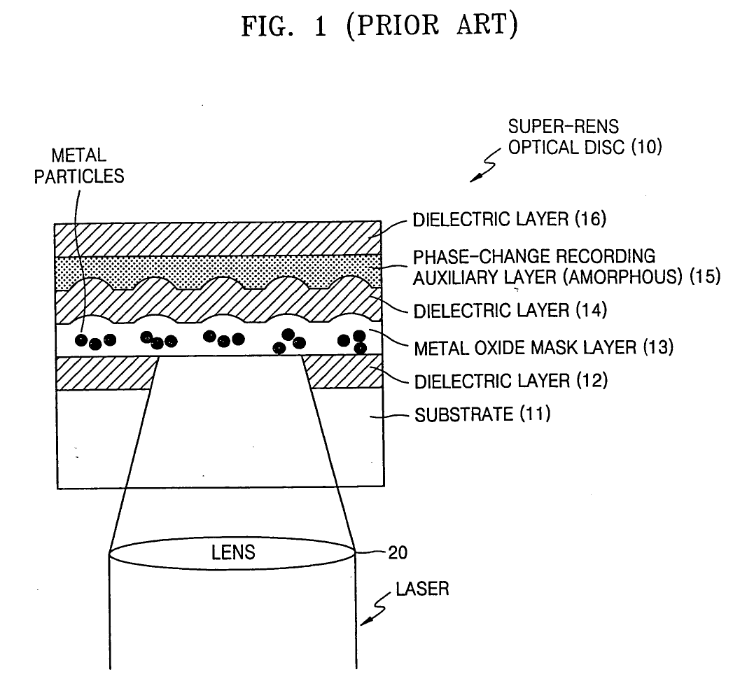

Furthermore, when a reading beam is incident for reproduction after recording data, the phase-change recording auxiliary layer 35 undergoes a transition from the amorphous state to the crystalline state more quickly and completely than a conventional layer 15 made from an amorphous material. Thus, the Super-RENS optical disc 30 makes it possible to minimize the fluctuation of an RF signal during reproduction, thereby allowing uniform stable signal reproduction. Contrary to the optical disc 30 of an aspect of the present invention, a conventional Super-RENS disc 10 shown in FIG. 1 suffers fluctuation due to slow and incomplete amorphous-to-crystalline phase transition. The highly crystalline material of the present invention is not limited to Sb₂Te₃ or Sb, but may include various other materials allowing quick crystallization.

For a conventional Super-RENS recording layer 15, since the as-deposited amorphous film has low reflectivity, an initialization process is required due to tracking servo failure. Since the phase-change recording auxiliary layer 15 undergoes incomplete transition to a crystalline state at high linear velocity of an optical disc 10 due to its low crystallization rate during initialization of the optical disc 10 for crystallization, a reproduced RF signal suffers from a large fluctuation. Thus, performing initialization at lower linear velocity allows considerably more stable RF signal reproduction according to an aspect of the invention.

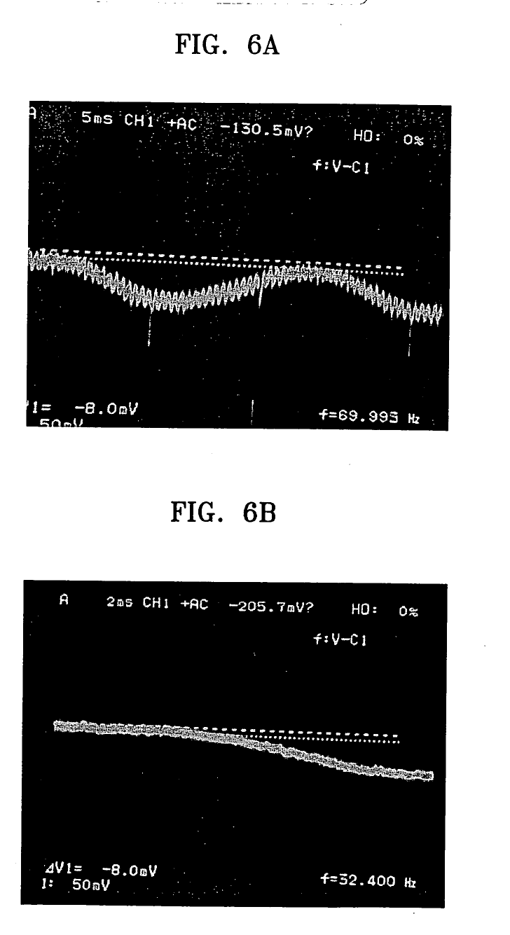

FIGS. 6A and 6B show RF signals reproduced from initialized Super RENS optical discs at linear velocities of 6 m/s and 3 m/s, respectively. As seen from FIGS. 6A and 6B, the RF signal reproduced from the initialized optical disc 30 at the linear velocity of 3 m/s is more stable than the RF signal at 6 m/s.

The same problem may occur upon reproduction after data has been recorded. That is, the phase-change recording layer undergoes transition to an amorphous state after data has been recorded. When a relatively high readout laser power is applied upon reproduction because of characteristics of a Super-RENS optical disc, the amorphous state is changed back to a crystalline state, which aggravates instability in the reproduced signal.

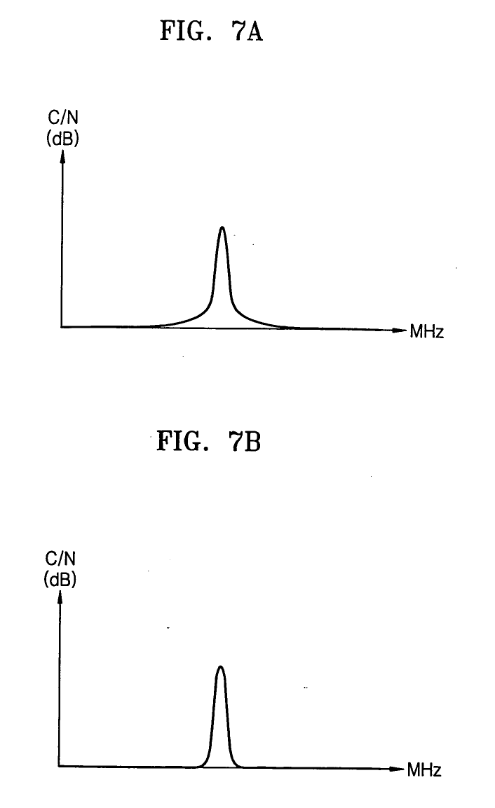

FIGS. 7A and 7B illustrate C/N characteristics measured on two Super-RENS optical discs having recording auxiliary layers with different crystallization rates using a spectrum analyzer. More specifically, FIG. 7A shows the C/N characteristic of an optical disc using a phase-change recording auxiliary layer containing 60 atomic percent of Sb, while FIG. 7B shows the C/N characteristic of an optical disc using a phase-change recording layer containing 70 atomic percent of Sb. Since the higher the content ratio of Sb, the higher the crystallization rate at the same linear velocity, the auxiliary layer containing 70 atomic percent of Sb exhibits better C/N characteristics than the auxiliary layer containing 60 atomic percent.

Thus, upon comparison between graphs of FIGS. 7A and 7B, C/N characteristics of the optical disc shown in FIG. 7B change more sharply than those shown in FIG. 7A. This implies that the higher content ratio of Sb increases the reaction rate of the phase-change recording and thus the data transfer rate.

Meanwhile, the phase-change recording auxiliary layer 35 may be used in, for example, rewritable, write-once, and read-only discs. Moreover, the layer 35 can be used in other optical disc types, such as in Bluray or Advanced Optical Discs (AODs). The auxiliary layer 35 can also be applied to single-sided dual-layer, double-sided single-layer, and double-sided dual-layer discs. Furthermore, the Super-RENS optical disc 30 may include a plurality of metal oxide mask layers 33 or a plurality of phase-change recording auxiliary layers 35.

As described above, the Super-RENS optical disc of the present invention has, among others, the following advantages. First, quality of a reproduced signal is improved by removing signal instability and unevenness that may occur due to incomplete crystallization of the phase-change recording auxiliary layer during reproduction of data. Second, high data transfer rate is allowed by minimizing a decrease in a C/N response rate due to a phase transition that the phase-change recording auxiliary layer undergoes during reproduction of data. Third, no initialization is required so low manufacturing costs and high production yields are allowed since the phase-change recording auxiliary layer is in a crystalline state immediately after its formation.

While the present invention has been particularly shown and described with reference to exemplary embodiments thereof, it will be understood by those of ordinary skill in the art that various changes in form and details may be made therein without departing from the spirit and scope of the present invention as defined by the following claims and equivalents thereof.

What is claimed is:

1. An optical disc having multi-layers formed on a substrate on which information is written by a beam, comprising:
one or more mask layers having a super-resolution near-field structure; and
one or more phase-change recording auxiliary layers, each recording auxiliary layer containing a highly crystalline material.

2. The optical disc of claim 1, wherein the phase-change recording auxiliary layer is in a crystalline state.

3. The optical disc of claim 1, wherein the highly crystalline material is antimony telluride (Sb₂Te₃) or Sb.

4. The optical disc of claim 1, wherein the phase-change recording auxiliary layer changes from an amorphous phase to a crystalline phase.

5. The optical disc of claim 3, wherein the Sb₂Te₃ or Sb are crystallized by kinetic energy of ions moving from a target toward the Sb₂Te₃ or Sb during thin film formation.

6. The optical disc of claim 3, wherein the highly crystalline material eliminates initialization of the optical disc.

7. The optical disc of claim 1, wherein fluctuation of an RF signal during data reproduction is minimized.

8. The optical disc of claim 1, wherein the phase-change auxiliary layer is rewritable.

9. The optical disc of claim 1, wherein the phase-change auxiliary layer is applied to single-sided dual-layer, double-sided single-layer and double-sided dual-layer optical discs.

10. An optical disc comprising:
a substrate;
a metal oxide mask layer formed on the substrate;
a phase-change recording auxiliary layer formed on the metal oxide mask layer; and
dielectric layers formed between the substrate, the metal oxide mask layer, and the phase-change auxiliary layer, wherein the phase-change recording auxiliary layer is a highly crystalline material.

11. The optical disc of claim 10, wherein the highly crystalline material is antimony telluride (Sb₂Te₃) or Sb.

12. The optical disc of claim 10, wherein the phase-change recording auxiliary layer is heated beyond a crystallization temperature into an amorphous phase and then changed back to a crystalline phase.

13. The optical disc of claim 11, wherein the Sb₂Te₃ or Sb are crystallized by kinetic energy of ions moving from a target toward the Sb₂Te₃ or Sb during thin film formation.

14. The optical disc of claim 11, wherein the highly crystalline material eliminates a need for initialization of the optical disc.

15. The optical disc of claim 10, wherein fluctuation of an RF signal during data reproduction is minimized.

16. The optical disc of claim 10, wherein the disc is a rewritable disc.

17. The optical disc of claim 10, wherein the disc is one of a single-sided dual-layer disc, double-sided single-layer disc and double-sided dual-layer optical disc.

18. A method of forming an optical disc, the method comprising:
forming a metal oxide mask layer on a substrate;
forming a phase-change recording auxiliary layer on the metal oxide mask layer; and
forming dielectric layers between the substrate and the metal oxide mask layer, between the metal oxide mask layer and the phase-change auxiliary layer, and on the phase-change auxiliary layer, wherein the phase-change recording auxiliary layer is formed from a highly crystalline material.

19. The method of claim 18, wherein the phase-change recording auxiliary layer is in a crystalline state after being formed.

20. The method of claim 18, wherein the highly crystalline material is antimony telluride (Sb₂Te₃) or Sb.

21. The method of claim 18, wherein the phase-change recording auxiliary layer is heated beyond a crystallization temperature into an amorphous phase and then changed back to a crystalline phase.

22. The method of claim 20, wherein the Sb₂Te₃ or Sb are crystallized by kinetic energy of ions moving from a target toward the Sb₂Te₃ or Sb during thin film formation.

23. The method of claim 20, wherein use of the highly crystalline material in the formation of the phase-change recording auxiliary layer eliminates need for initialization of the disc.

24. The method of claim 18, wherein fluctuation of an RF signal during data reproduction is minimized.

25. The optical disc of claim 1, wherein the highly crystalline material contains more than 60 atomic percent of Sb.

26. The optical disc of claim 10, wherein the highly crystalline material contains more than 60 atomic percent of Sb.

27. The method of claim 18, wherein the highly crystalline material contains more than 60 atomic percent of Sb.
